(19) United States
(12) Patent Application Publication
(10) Pub. No.: US 2024/0005201 A1
(43) Pub. Date: Jan. 4, 2024

(54) MULTI-STEP FORECASTING VIA TEMPORAL AGGREGATION

(71) Applicant: Oracle International Corporation, Redwood Shores, CA (US)

(72) Inventors: Ankit Kumar Aggarwal, Mumbai (IN); Lakshmi Sirisha Chodisetty, Bangalore (IN); Samik Raychaudhuri, Bangalore (IN)

(73) Assignee: Oracle International Corporation, Redwood Shores, CA (US)

(21) Appl. No.: 17/854,487

(22) Filed: Jun. 30, 2022

(51) Int. Cl. G06N 20/00; G06K 9/62; G06F 16/2458

(52) U.S. Cl. CPC G06N 20/00; G06F 16/2477; G06K 9/6248; G06K 9/6242

(57) ABSTRACT

Aspects if the disclosure are directed towards multi-step forecasting via temporal aggregation. An example embodiment includes a method the includes receiving a time series including a first time step value and a second time step value. The method can further include generating a temporally aggregated time series by summing the first time step value and the second time step value to create a third time step value. The method can further include calculating a first set of input values and a second set of input values from the temporally aggregated time series. The method can further include forecasting a fourth time step value using the first set of input values and the second set of input values, and a fifth time step using the second set of input values from the temporally aggregated time series.

### BACKGROUND

A cloud service provider (CSP) can provide multiple cloud services to subscribing customers. These services are provided under different models, including a Software-as-a-Service (SaaS) model, a Platform-as-a-Service (PaaS) model, an Infrastructure-as-a-Service (IaaS) model, and others. In many instances, a cloud services provider can offer on-demand services, such as a forecasting service.

### BRIEF SUMMARY

The present embodiments relate to multi-step forecasting via temporal aggregation. A first exemplary embodiment provides a computer-implemented method for multi-step forecasting via temporal aggregation. The method can include receiving a time series, including a first time step value and a second time step value.

The computer-implemented method can further include generating a temporally aggregated time series by summing the first time step value and the second time step value to create a third time step value.

The computer-implemented method can further include calculating a first set of input values and a second set of input values from the temporally aggregated time series.

The computer-implemented method can further include forecasting a fourth time step value using the first set of input values and the second set of input values, and a fifth time step using the second set of input values from the temporally aggregated time series.

A second exemplary embodiment relates to a cloud infrastructure node. The cloud infrastructure can include a processor and a non-transitory computer-readable medium. The non-transitory computer-readable medium can include instructions that, when executed by the processor, cause the processor to receive a time series, including a first time step value and a second time step value.

The instructions can further cause the processor to generate a temporally aggregated time series by summing the first time step value and the second time step value to create a third time step value.

The instructions can further cause the processor to calculate a first set of input values and a second set of input values from the temporally aggregated time series.

The instructions can further cause the processor to forecast a fourth time step value using the first set of input values and the second set of input values, and a fifth time step using the second set of input values from the temporally aggregated time series.

A third exemplary embodiment relates to a non-transitory computer-readable medium. The non-transitory computer-readable medium can include stored thereon a sequence of instructions which, when executed by a processor, cause the processor to execute a process. The process can include receiving a time series, including a first time step value and a second time step value.

The process can further include generating a temporally aggregated time series by summing the first time step value and the second time step value to create a third time step value.

The process can further include calculating a first set of input values and a second set of input values from the temporally aggregated time series.

The process can further include forecasting a fourth time step value using the first set of input values and the second set of input values, and a fifth time step using the second set of input values from the temporally aggregated time series.

### BRIEF DESCRIPTION OF THE DRAWINGS

FIG. 1 illustrates a system for multi-step forecasting, according to one or more embodiments.

FIG. 2 illustrates a time step value aggregation, according to one or more embodiments.

FIG. 3 illustrates a process for time step value aggregation, according to one or more embodiments.

FIG. 4 illustrates a process for time step value aggregation, according to one or more embodiments.

FIG. 5 illustrates a process for time step value aggregation, according to one or more embodiments.

FIG. 6 is a block diagram illustrating a pattern for implementing a cloud infrastructure as a service system, according to one or more embodiments.

FIG. 7 is a block diagram illustrating another pattern for implementing a cloud infrastructure as a service system, according to one or more embodiments.

FIG. 8 is a block diagram illustrating another pattern for implementing a cloud infrastructure as a service system, according to one or more embodiments.

FIG. 9 is a block diagram illustrating another pattern for implementing a cloud infrastructure as a service system, according to one or more embodiments.

FIG. 10 is a block diagram illustrating an example computer system, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Machine learning systems can be configured for time series forecasting algorithms that can receive input data and output a forecasted value derived from features observed in the input data. In typical applications, an algorithm is tasked with analyzing historical data in a time series and predicting the next time step value. In some instances, a machine learning algorithm can be tasked with predicting values for multiple time steps into the future or otherwise known as multi-step forecasting. There are several generally accepted multi-forecasting techniques, including direct multi-step forecasting, recursive multi-step forecasting, direct-recursive hybrid multi-step forecasting, and multiple output forecasting. Each of these techniques relies upon a single model predicting each additional value after the first predicted value based on a prior predicted value. For example, if a machine learning system is tasked with predicting values for three future time steps, the first predicted value relies on the historical data, the second predicted value relies on the first predicted value and the historical data, and the third predicted value relies on the second predicted value and the historical data. Therefore, an error associated with predicting the first predicted value carries through the second predicted value. Furthermore, the error associated with the first predicted value and the second predicted value carries over to the third predicted value, and so on for any successive predicted value.

Embodiments described herein address the above-described issues by using separate forecasting models in combination with temporally aggregated data points for forecasting. In particular, a time series and a request for predictions can be received from a source. Based on the time series, a temporally aggregated time series can be created. A set of features (properties) can be extracted from the time series, and the same set of features can be extracted from the temporally aggregated time series. A separate model is employed for each successive predicted value. In this sense, the errors of a model predicting a first time step value do not carry over to another model predicting a successive time step value.

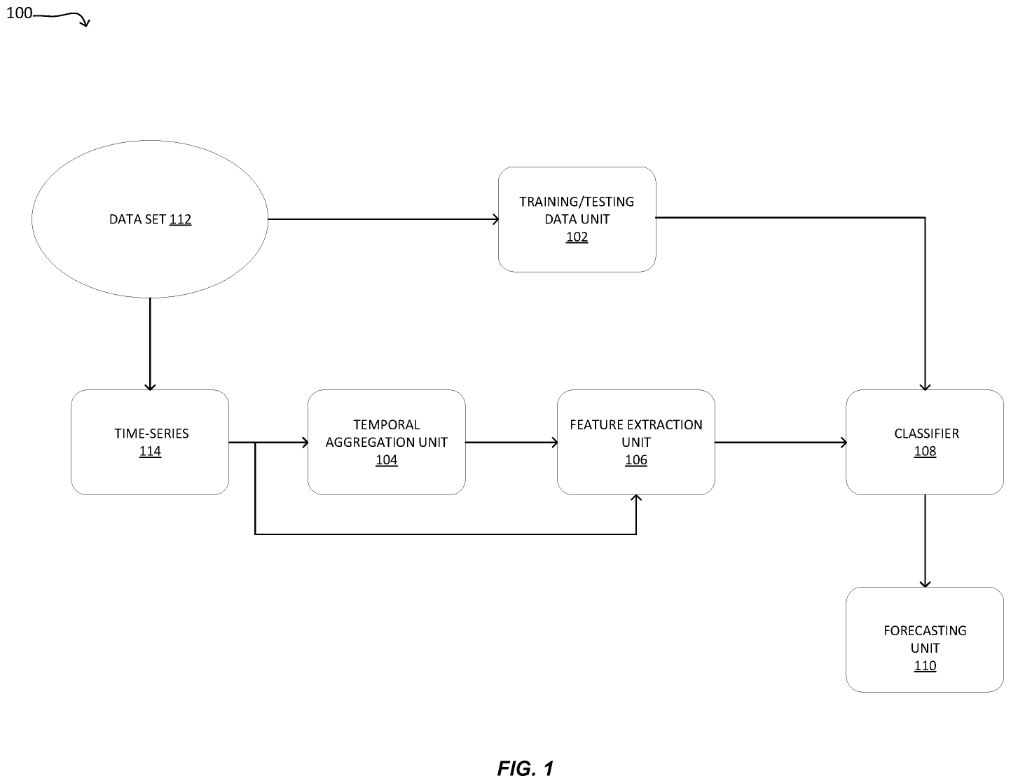

Referring to FIG. 1, a system 100 for multi-step forecasting using temporally aggregated data according to some embodiments is shown. The system 100 can include a training/testing unit 102, a temporal aggregation unit 104, a feature extraction unit 106, a classifier 108, and a forecasting unit 110. The system 100 can receive a data set 112, which can include a time series. The data set 112 can be received from a source, and in addition to the time series, the source can provide a request to generate predictions for a future time step.

The training/test unit 102 can receive data from a data set for training the classifier 108. In some instances, the data set 112 can include a training data set for training the classifier. The training set can include a set of objects with known classification. The training/test unit 102 can pre-process the training data set for ingestion by the classifier 108. The training/testing unit 102 can further assess the accuracy of the classifier 108.

The classifier 108 can include a machine learning algorithm that can be trained to assign a class or numeric value to an input, such as a time series feature. In particular, the classifier 108 can be trained to predict a class of given input. Classification can be performed based on a mapping function from input features (e.g., time series features) to discrete output variables (e.g., “predicted values”).

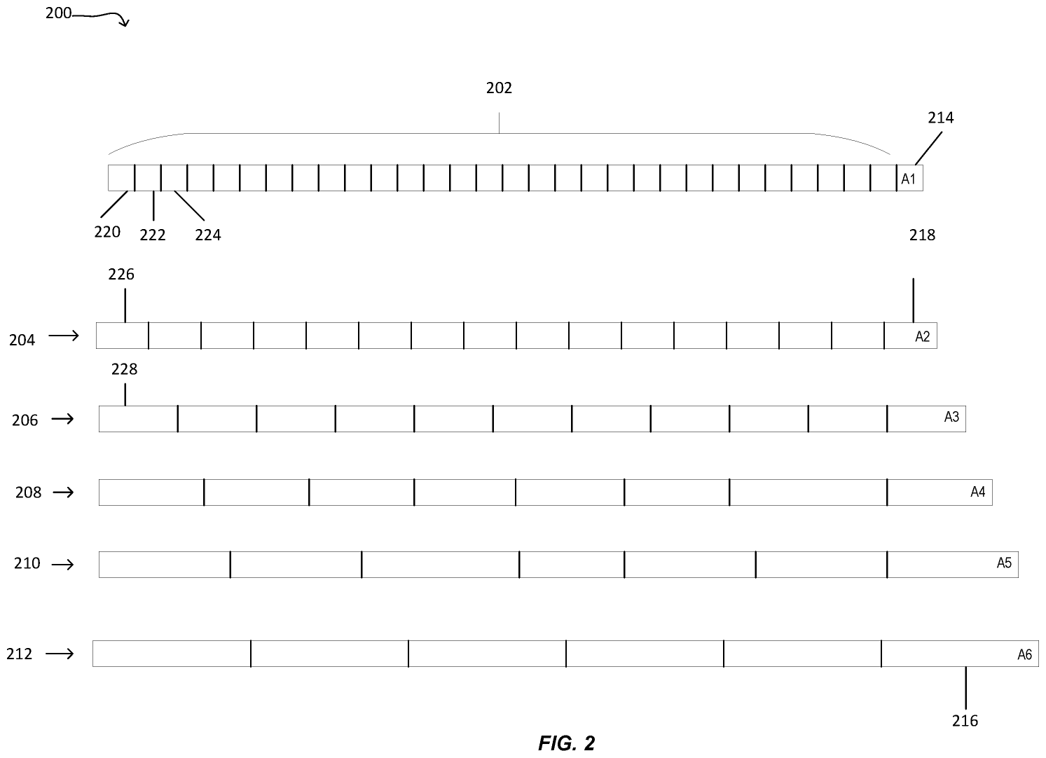

The temporal aggregation unit 104 can receive data, such as a time series 114, and generate a temporally aggregated time series based on a time step of a requested prediction. The temporal aggregation unit 104 can perform various techniques for aggregating data points of a time series. For example, the temporal aggregation unit 104 can perform a temporal aggregation of data points. Temporal aggregation of the data points is described in more detail with respect to FIG. 2.

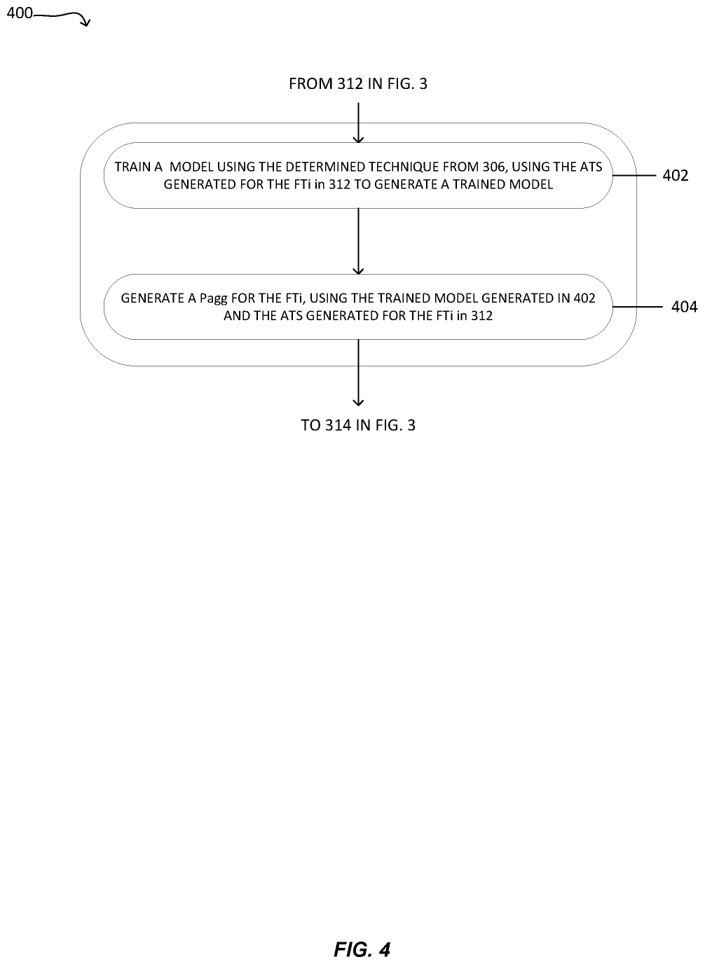

The feature extraction unit 106 can extract features from a time series to transform the time series into numerical features that can be received by the classifier 108. The feature extraction unit 106 can receive a time series as provided in the data set 112. Through feature extraction unit 106, the system can reduce the dimensionality of the time series to make the data more manageable for the classifier 108. The feature extraction unit 106 can further be configured to extract features that guide a forecasting technique selection. The particular features are described in more detail with respect to FIG. 4.

The forecasting unit 110 can include a suite of forecasting techniques. The forecasting unit 110 can further select a technique from the suite of techniques based on the extracted features. The forecasting unit 110 can further employ a model implemented the technique to receive data from the classifier 108 and predict a data point at a future time step. The forecasting unit 110 can be configured to employ various methods for generating a predicted value. For example, the forecasting unit 110 can apply qualitative techniques, time series analysis and projection, or causal models. In some embodiments, the forecasting unit 110 can apply an autoregressive moving average technique or a K-nearest neighbor (KNN) technique.

Referring to FIG. 2, an illustration 200 of non-aggregated and temporally aggregated time series, according to some embodiments is shown. As illustrated, there are six time series, including a first time series 202, a second time series 204, a third time series 206, a fourth time series 208, a fifth time series 210, and a sixth time series 212. The first time series 202 can be data points collected from a source (e.g., data set 112). The data points can be, for example, temperature values for the past ten years, birth rates in the past thirty months, or other collected data. Each data point can be associated with a value and time point. A first future data point 214 is illustrated at the tail end of the first time series 202. The future data point 214 can be associated with a value and a future time point. It should be appreciated that the first future data point 214 is presented for illustration purposes and is generated through a forecasting process using the historical data points of the first time series 202.

The second time series 204, the third time series 206, the fourth time series 208, the fifth time series 210, and the sixth time series 212 can be temporally aggregated time series that are generated for multi-step forecasting. Each of the temporally aggregated time series has a future data point illustrated at a respective tail end. As illustrated, the first time series 202 includes thirty data points and a first future data point 214. The sixth time series 212 includes five data points and one forecasted time step value.

The first time series 202 can be used for predicting the first future data point 214, FT₁. For example, a computing device (e.g., system 100) can apply the data points as inputs for a forecasting technique and extrapolate a future value at a future time point. Each subsequent time series can be used for predicting a next forecasted time step value (FT₁₊ᵢ). This length of time that a time series is used to make a prediction can be known as a horizon. For example, if a computing device is tasked with using the first time series 202 to make a prediction for one month into the future, the horizon is one month. For the second time series 204, the computing device is tasked with making a prediction two months into the future; the horizon is two months.

The first time series 202 can include a collection of data points, wherein each data point is associated with a value and a time point. Each subsequent time series can be generated based on a temporal aggregation of two or more sequential data points of the first time series 202. In some embodiments, the number of sequential data points that are temporally aggregated can be based on a number of time steps in the future that a computing device is tasked with predicting. For example, if the computing device is tasked with predicting two time steps into the future, a temporally aggregated data point can be generated based on aggregation of two data points of the first time series 202.

As an illustrative example, a computing device can be provided the first time series 202 and be tasked with predicting a first future data point 214 at one time step into the future and a second future data point 218 at two time steps into the future. The computing device (e.g., via a forecasting unit 110) can generate the first future data point 214, for example, by applying the data points of the first time series 202 as inputs for one of the above-referenced forecasting techniques.

The computing device (e.g., via a temporal aggregation unit 122) can generate the second future data point 218 by generating a temporally aggregated time series (e.g., the second time series 204), and using the temporally aggregated time series to generate the second future data point 218. The computing device can segment the data points of the first time series 202 into sets of sequential values. The number of data points in each set can be based on the number of time steps into the future that the prediction is for. In this illustration, the prediction is for a data point that is two time steps into the future. Therefore, each set can be generated from two sequential data points of the first time series 202. For example, a first data point 220 and a sequential second data point 222 can be retrieved from the first time series 202. Each of the first data point 220 and the sequential second data point 222 can be associated with a respective value and time step. The computing device can calculate a sum of the value associated with the first data point 220 and a value associated with the sequential second data point 222 to generate a value associated with a fourth data point 226. The time step associated with the sequential second data point 222 can be associated with the fourth data point 226. Adding values to the example, the first data point 220 can be associated with a value of 120 and a time step of March 2019, and the sequential second data point 222 can be associated with a value of 80 and a time step of April 2019. The computing device can calculate a sum of the data point values and reach a value of 200 (120+80=200). The computing device can then associate a value of 200 and a time step of April 2019 with the fourth data point 226, as April 2019 is the later of the time steps. This process can repeat itself with subsequent data points of the first time series until the second time series is built. As illustrated, the first time series 202 includes thirty data points, and the second time series includes fifteen data points generated from sequential data point pairs of the first time series 202.

This process can further repeat itself for generating new temporally aggregated time series. For example, if a computing device is tasked with predicting a data point at three time steps into the future, the computing device can generate a temporally aggregated data point (e.g., a data point for the third time series 206) by calculating a sum of the first data point 220, the sequential second data point, 222, and a sequential third data point 224 for a fifth data point 228. The time step value associated with the fifth data point 228 can be a time step value associated with the last (youngest) data point of the set. In this example, the fifth data point 228 is associated with a time step of the sequential third data point 224.

It should be appreciated that in some instances, a number of data points in a time series can be removed prior to temporal aggregation. This situation can occur, for example, when after temporally aggregating data points of a time series, a fewer than the number of data points to be aggregated remains in the time series. In this situation, the oldest data points can be removed from the time series prior to temporal aggregation.

Take, for example, the first time series 202 and fourth time series 208. As illustrated, the first time series 202 includes thirty data points. Furthermore, the data points of the fourth time series 208 can be generated by aggregating sets of four sequential data points of the first time series 202. Doing so can generate seven aggregated data points for the fourth time series 208 but leaves two data points of the first time series 202 remaining. Therefore, the process can include discarding a number of the oldest data points, such that no data points remain after temporal aggregation. In this example, the number of data points remaining, if no discarding occurs, is two. Therefore, the process can include discarding the first two data points of the time series. For example, the process can include discarding the first data point 220 and the sequential second data point 222 of the first time series. In this case, temporal aggregation can begin at the sequential third data point 224.

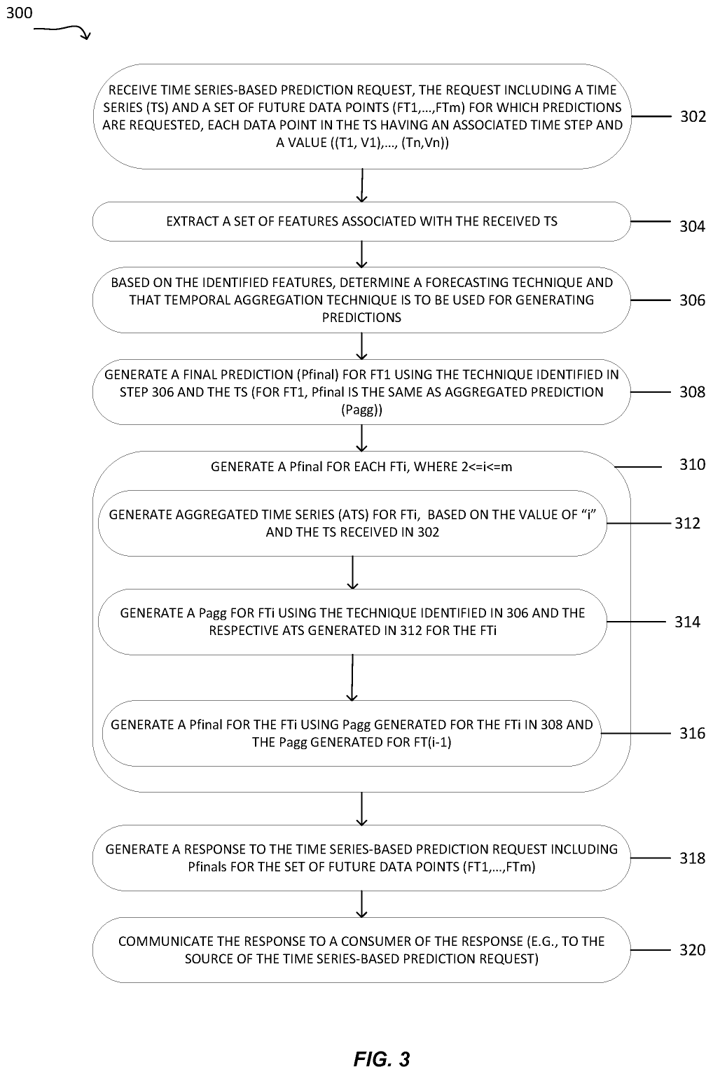

Referring to FIG. 3, a process 300 for generating a forecast using temporally aggregated data, according to some embodiments is shown. While the operations of processes 300, 400, and 500 are described as being performed by generic computers, it should be understood that any suitable device (e.g., a user device, a server device) may be used to perform one or more operations of these processes. Processes 300, 400, and 500 (described below) are respectively illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At 302, a computing device can receive a time series-based prediction request. The prediction request can include a time series, where the time series can include a collection of data points. The request can further include a set of future data points (FT₁, . . . , FTₘ) for which predictions are requested. Each data point of the time series can be associated with a time step and a value ((T₁, V₁), . . . , (Tₙ, Vₙ)). It should be appreciated that the first future data point FT₁ is the nearest in time to the last data point of the time series. For example, if the time series is monthly data and the last time step of the time series is August 2010, FT₁ can be September 2010, and FT₂ can be October 2010.

At 304, the computing device can extract a set of features from the received time series. The features can be extracted based on having characteristics that can be analyzed to determine that a time series should be temporally aggregated for multi-step forecasting versus the time series should not be temporally aggregated for multi-step forecasting. The features should provide information regarding, for example, a trend, seasonality, autocorrelation, nonlinearity, or a heterogeneity of the time series.

At 306, the computing device can determine a forecasting technique and that the time series should be temporally aggregated for multi-step forecasting. The forecasting technique can be implemented by a model to generate an estimate of a future data point. The forecasting technique can be, for example, an autoregressive moving average technique (ARMA) such as an autoregressive integrated moving average (ARIMA) technique. As described above, each requested future data point is generated by a respective model. Each model can implement the same forecasting technique but ingest a time series that has been aggregated differently. For example, a model, ARIMA1, can ingest a temporally aggregated time series in which a sum of the values of two sequential data points are used to generate a temporally aggregated data point. Additionally, another model, ARIMA2, can ingest a temporally aggregated time series in which a sum of the values of three sequential data points are used to generate a temporally aggregated data point.

At 308, the computing device can generate a final prediction (P_{final}) for FT₁ using the technique identified in step 306 and the time series. It should be appreciated that for FT₁, P_{final} is a prediction as an aggregated prediction (P_{agg}) and the value that is returned to the source of the request of step 302.

At 310, the computing device can generate a P_{final} for the balance of the set of future data points (FT₂, . . . , FTₘ) for which predictions are requested, wherein “i” is greater than or equal to 2, and less than or equal to “m” (e.g., 2<=i<=m). As described herein, steps 312 through 316 are used for each future data of the above-referenced balance of the set of future data points (FT₂, . . . , FTₘ), respectively.

At 312, the computing device can generate a temporally aggregated time series (ATS) for FT′, based on the value of “i” and the time series received in 302. The aggregation can be as described with respect to FIG. 2.

At 312, the computing device can generate a P_{agg} for FTᵢ using a model that implements the technique determined in step 306 and the aggregated time series generated in 312 for the FTᵢ.

At 316, the computing device can generate a P_{final} for the FTᵢ for the P_{agg} generated for the FTᵢ in step 314 and a P_{agg} generated for FT₍ᵢ₋₁₎. As an illustration, refer to FIG. 2, it can be seen that the first future data point 214 (represented as “A1”) is generated for the first time series 202 and the second future data point 218 (represented as “A2”) is generated for the second time series 204. In practice, a second model generates the second future data point 218 independently from a first model that generates the first future data point 214. To generate the second future data point 218, the second model generates a predicted value for a first future data point and a predicted value for the requested future data point based on the predicted first future data point. The second future data point 218, as seen in FIG. 2, is an aggregated prediction of both of these values. To generate the final prediction (P_{final}) for FT₂, the second model can subtract the P_{agg} for FT₂ from the P_{final} for FT₁ (A2−A1=P_{final} for FT₂).

At 318 the computing device can generate a response to the time series-based prediction request, including P_{finals} for the set of future data points (FT₁, . . . , FTₘ).

At 320, the computing device can communicate the response to a consumer of the response. The consumer can be, for example, the source of the request from step 302.

Referring to FIG. 4, a process 400 for training a model for forecasting according to some embodiments is shown. Process 400 is an embodiment that can follow step 312 of FIG. 3. At 402, the computing device can train a model using the determined forecasting technique of step 306 and the aggregated time series generated for the FTᵢ in step 312. The training can be performed until, for example, the model reaches a threshold accuracy as determined by the training/testing unit 102.

At 404, the computing device can generate a P_{agg} for the FTᵢ, using the trained model of step 402 and the generated aggregated time series generated for the FTᵢ in step 312. After generating the P_{agg}, the process 400 can proceed to step 314 of FIG. 3.

It should be appreciated that an alternative to the embodiment described by FIG. 4, is using a model that has been pre-trained for the determined forecasting technique of step 306.

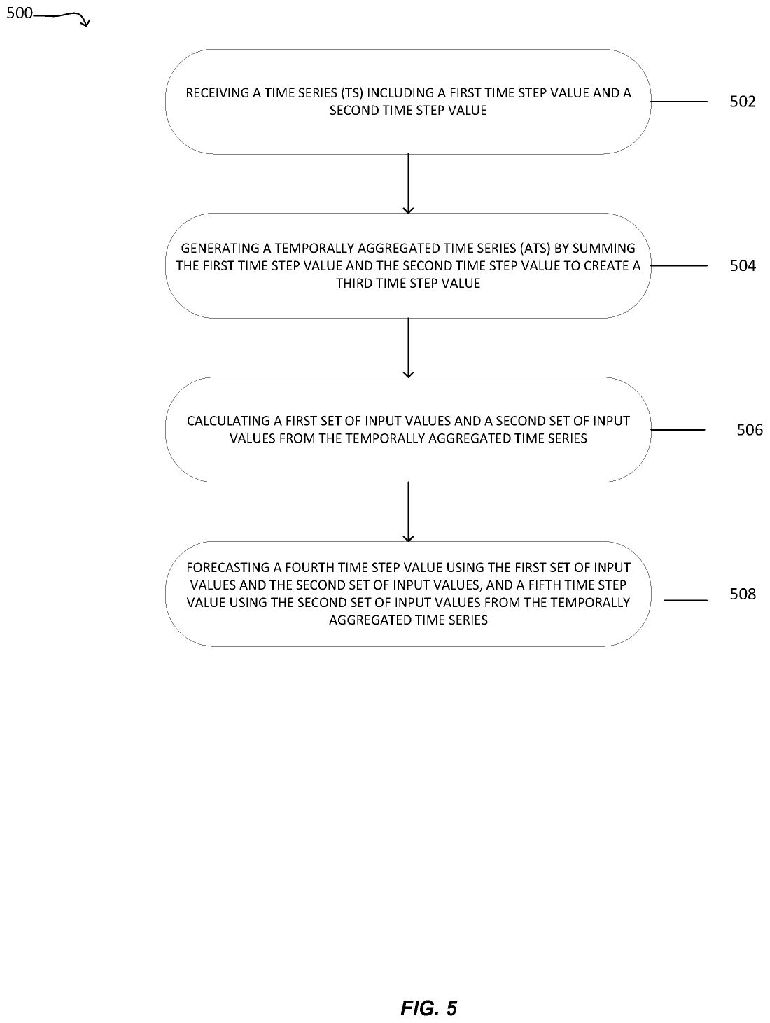

Referring to FIG. 5, a process flow 500 for forecasting a time series according to some embodiments is shown. At 502, a computing device can receive a time series including a first time step value and a second time step value. The time series can be received pursuant to a request to forecast future data points.

At 504, the computing device can generate a temporally aggregated data time series by summing the first time step value and the time step value to create a third time step value. The summing can be as described with respect to FIG. 2.

At 506, the computing device can calculate a first set of input values and a second set of input values from the temporally aggregated time series. The first set of input values can be, for example, to generate a first future data point. The second set of input values can be, for example, to generate a second future data point.

At 508, the computing device can forecast a fourth time step value using the first set of input values and the second set of input values, and a fifth set time step value using the second set of input values from the temporally aggregated time series. The fourth time step value can be, for example, a predicted time step value. The fifth time step value can be, for example, another predicted time step value.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing, and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed may first need to be set up. In some instances, the provisioning can be done manually, a provisioning tool may be utilized to provision the resources, and/or deployment tools may be utilized to deploy the code once the infrastructure is provisioned.

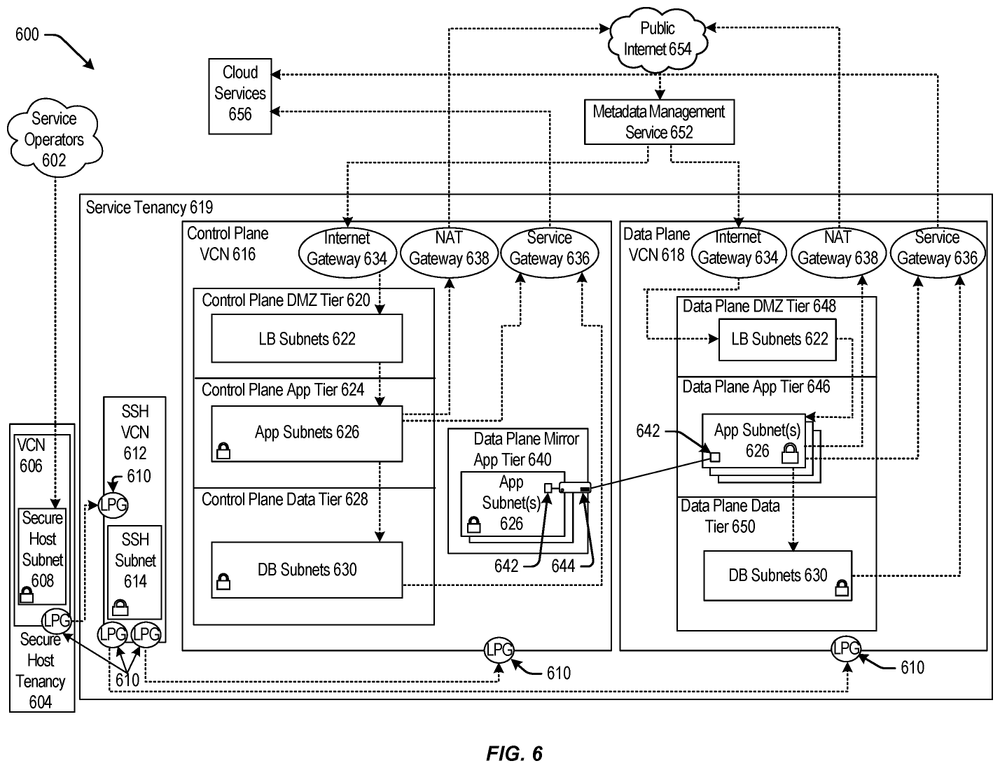

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 14, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 contained in the SSH VCN 612. The SSH VCN 612 can include an SSH subnet 614, and the SSH VCN 612 can be communicatively coupled to a control plane VCN 616 via the LPG 610 contained in the control plane VCN 616. Also, the SSH VCN 612 can be communicatively coupled to a data plane VCN 618 via an LPG 610. The control plane VCN 616 and the data plane VCN 618 can be contained in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 contained in the control plane DMZ tier 620 can be communicatively coupled to the app subnet(s) 626 contained in the control plane app tier 624 and an Internet gateway 634 that can be contained in the control plane VCN 616, and the app subnet(s) 626 can be communicatively coupled to the DB subnet(s) 630 contained in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 contained in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be contained in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively couple to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way: the service gateway 636 can make API calls to cloud services 656, and cloud services 656 can send requested data to the service gateway 636. But, cloud services 656 may not initiate API calls to the service gateway 636.

In some examples, the secure host tenancy 604 can be directly connected to the service tenancy 619, which may be otherwise isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision desired resources. Desired resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be contained in the data plane mirror app tier 640 and the data plane app tier 646.

In some examples, users of the system, or customers, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 contained in the control plane DMZ tier 620. The LB subnet(s) 622 may determine that the request is valid, and in response to this determination, the LB subnet(s) 622 can transmit the request to app subnet(s) 626 contained in the control plane app tier 624. If the request is validated and requires a call to public Internet 654, the call to public Internet 654 may be transmitted to the NAT gateway 638 that can make the call to public Internet 654. Memory that may be desired to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to configuration may be desired to be applied to the resources contained in the data plane VCN 618. Via a VNIC 642, the control plane VCN 616 can directly communicate with, and can thereby execute the changes, updates, or other suitable modifications to configuration to, resources contained in the data plane VCN 618.

In some embodiments, the control plane VCN 616 and the data plane VCN 618 can be contained in the service tenancy 619. In this case, the user, or the customer, of the system may not own or operate either the control plane VCN 616 or the data plane VCN 618. Instead, the IaaS provider may own or operate the control plane VCN 616 and the data plane VCN 618, both of which may be contained in the service tenancy 619. This embodiment can enable isolation of networks that may prevent users or customers from interacting with other users', or other customers', resources. Also, this embodiment may allow users or customers of the system to store databases privately without needing to rely on public Internet 654, which may not have a desired level of threat prevention, for storage.

In other embodiments, the LB subnet(s) 622 contained in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may desire this embodiment since database(s) that the customers use may be controlled by the IaaS provider and may be stored on the service tenancy 619, which may be isolated from public Internet 654.

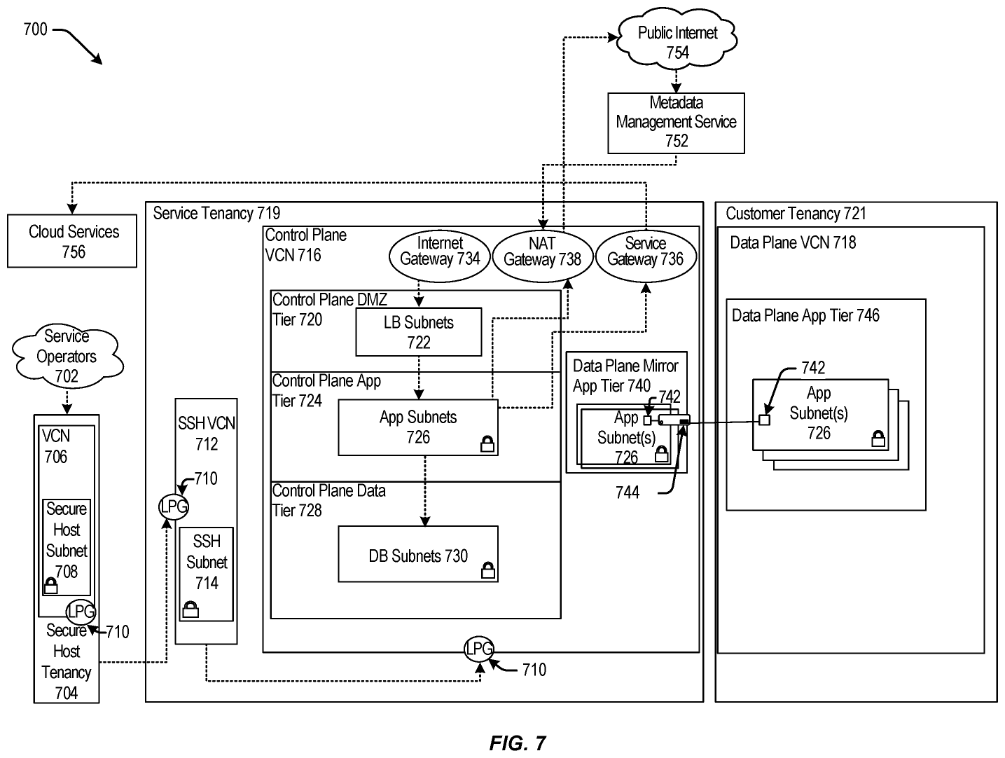

FIG. 7 is a block diagram 700 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 776 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 710 contained in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 contained in the control plane VCN 716. The control plane VCN 716 can be contained in a service tenancy 719 (e.g., the service tenancy 619 of FIG. 6), and the data plane VCN 718 (e.g., the data plane VCN 618 of FIG. 6) can be contained in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), a control plane data tier 728 (e.g., the control plane data tier 628 of FIG. 6) that can include database (DB) subnet(s) 730 (e.g., similar to DB subnet(s) 630 of FIG. 6). The LB subnet(s) 722 contained in the control plane DMZ tier 720 can be communicatively coupled to the app subnet(s) 726 contained in the control plane app tier 724 and an Internet gateway 734 (e.g., the Internet gateway 634 of FIG. 6) that can be contained in the control plane VCN 716, and the app subnet(s) 726 can be communicatively coupled to the DB subnet(s) 730 contained in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 contained in the data plane mirror app tier 740 can include a virtual network interface controller (VNIC) 742 (e.g., the VNIC of 642 of FIG. 6) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be contained in a data plane app tier 746 (e.g., the data plane app tier 746 of FIG. 7) via the VNIC 742 contained in the data plane mirror app tier 740 and the VNIC 742 contained in the data plane app tier 746.

The Internet gateway 734 contained in the control plane VCN 716 can be communicatively coupled to a metadata management service 752 (e.g., the metadata management service 602 of FIG. 6) that can be communicatively coupled to public Internet 754 (e.g., public Internet 604 of FIG. 6). Public Internet 754 can be communicatively coupled to the NAT gateway 738 contained in the control plane VCN 716. The service gateway 736 contained in the control plane VCN 716 can be communicatively couple to cloud services 756 (e.g., cloud services 656 of FIG. 6).

In some examples, the data plane VCN 718 can be contained in the customer tenancy 721. In this case, the IaaS provider may provide the control plane VCN 716 for each customer, and the IaaS provider may, for each customer, set up a unique compute instance 744 that is contained in the service tenancy 719. Each compute instance 744 may allow communication between the control plane VCN 716, contained in the service tenancy 719, and the data plane VCN 718 that is contained in the customer tenancy 721. The compute instance 744 may allow resources, that are provisioned in the control plane VCN 716 that is contained in the service tenancy 719, to be deployed or otherwise used in the data plane VCN 718 that is contained in the customer tenancy 721.

In other examples, the customer of the IaaS provider may have databases that live in the customer tenancy 721. In this example, the control plane VCN 716 can include the data plane mirror app tier 740 that can include app subnet(s) 726. The data plane mirror app tier 740 can reside in the data plane VCN 718, but the data plane mirror app tier 740 may not live in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity contained in the control plane VCN 716. The customer may desire to deploy or otherwise use resources in the data plane VCN 718 that are provisioned in the control plane VCN 716, and the data plane mirror app tier 740 can facilitate the desired deployment, or other usage of resources, of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, contained in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be live or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 1,” may be located in Region 1 and in “Region 2.” If a call to Deployment 1 is made by the service gateway 736 contained in the control plane VCN 716 located in Region 1, the call may be transmitted to Deployment 1 in Region 1. In this example, the control plane VCN 716, or Deployment 1 in Region 1, may not be communicatively coupled to, or otherwise in communication with, Deployment 2 in Region 2.

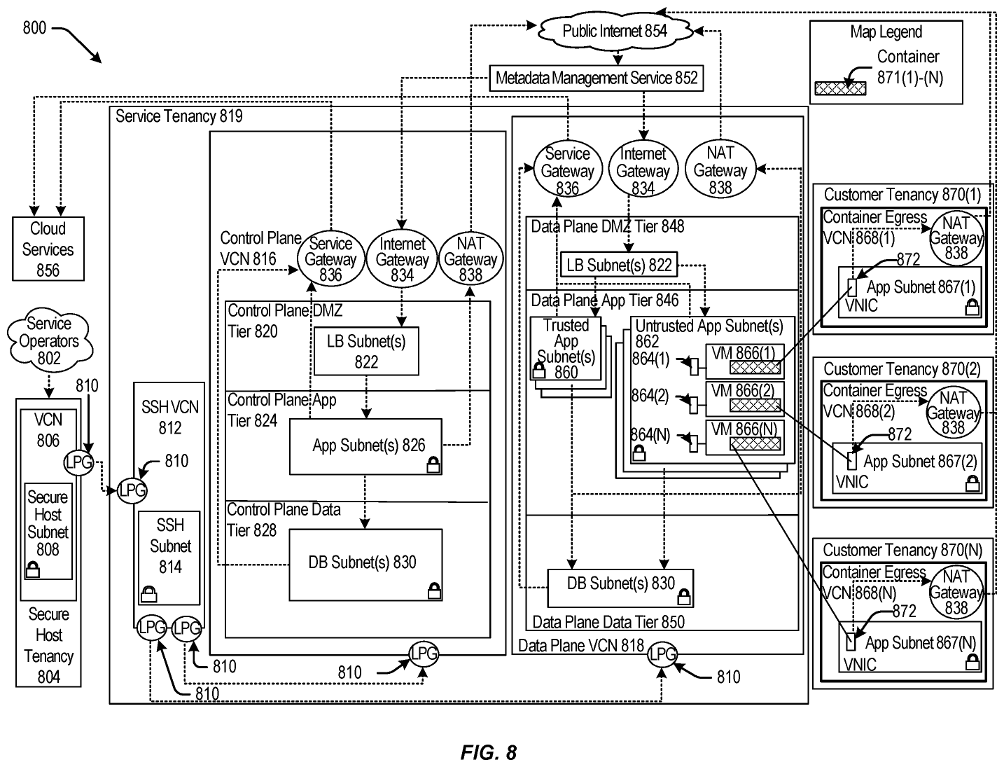

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 806 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 contained in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 contained in the control plane VCN 816 and to a data plane VCN 818 (e.g., the data plane 618 of FIG. 6) via an LPG 810 contained in the data plane VCN 818. The control plane VCN 816 and the data plane VCN 818 can be contained in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), a control plane data tier 828 (e.g., the control plane data tier 628 of FIG. 6) that can include DB subnet(s) 830. The LB subnet(s) 822 contained in the control plane DMZ tier 820 can be communicatively coupled to the app subnet(s) 826 contained in the control plane app tier 824 and to an Internet gateway 834 (e.g., the Internet gateway 634 of FIG. 6) that can be contained in the control plane VCN 816, and the app subnet(s) 826 can be communicatively coupled to the DB subnet(s) 830 contained in the control plane data tier 828 and to a service gateway 836 (e.g., the service gateway 636 of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860 and untrusted app subnet(s) 862 of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include one or more primary VNICs 864(1)-(N) that can be communicatively coupled to tenant virtual machines (VMs) 866(1)-(N). Each tenant VM 866(1)-(N) can be communicatively coupled to a respective app subnet 867(1)-(N) that can be contained in respective container egress VCNs 868(1)-(N) that can be contained in respective customer tenancies 870(1)-(N). Respective secondary VNICs 872(1)-(N) can facilitate communication between the untrusted app subnet(s) 862 contained in the data plane VCN 818 and the app subnet contained in the container egress VCNs 868(1)-(N). Each container egress VCNs 868(1)-(N) can include a NAT gateway 838 that can be communicatively coupled to public Internet 854 (e.g., public Internet 654 of FIG. 6). The Internet gateway 834 contained in the control plane VCN 816 and contained in the data plane VCN 818 can be communicatively coupled to a metadata management service 852 (e.g., the metadata management system 652 of FIG. 6) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some embodiments, the data plane VCN 818 can be integrated with customer tenancies 870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 846. Code to run the function may be executed in the VMs 866(1)-(N), and the code may not be configured to run anywhere else on the data plane VCN 818. Each VM 866(1)-(N) may be connected to one customer tenancy 870. Respective containers 871(1)-(N) contained in the VMs 866(1)-(N) may be configured to run the code. In this case, there can be a dual isolation (e.g., the containers 871(1)-(N) running code, where the containers 871(1)-(N) may be contained in at least the VM 866(1)-(N) that are contained in the untrusted app subnet(s) 862), which may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completion of running the code, the IaaS provider may kill or otherwise dispose of the containers 871(1)-(N).

In some embodiments, the trusted app subnet(s) 860 may run code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be contained in the VM 866(1)-(N) of each customer and that may run code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

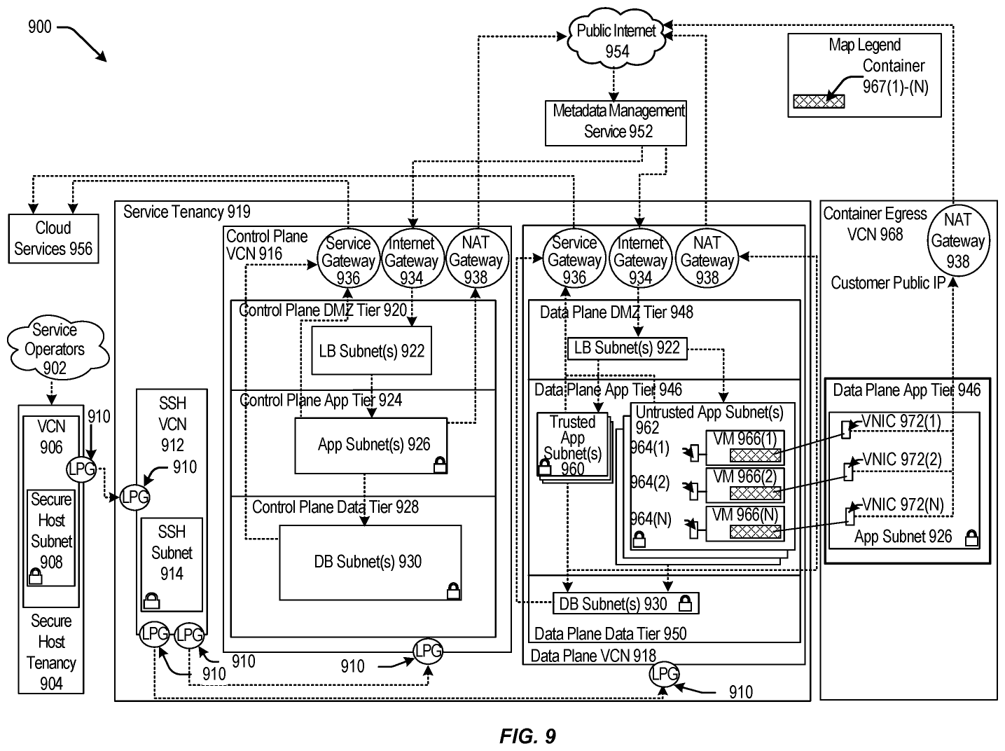

FIG. 9 is a block diagram 900 illustrating another example pattern of an IaaS architecture, according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 contained in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 contained in the control plane VCN 916 and to a data plane VCN 918 (e.g., the data plane 618 of FIG. 6) via an LPG 910 contained in the data plane VCN 918. The control plane VCN 916 and the data plane VCN 918 can be contained in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), a control plane data tier 928 (e.g., the control plane data tier 628 of FIG. 6) that can include DB subnet(s) 930 (e.g., DB subnet(s) 630 of FIG. 6). The LB subnet(s) 922 contained in the control plane DMZ tier 920 can be communicatively coupled to the app subnet(s) 926 contained in the control plane app tier 924 and to an Internet gateway 934 (e.g., the Internet gateway 634 of FIG. 6) that can be contained in the control plane VCN 916, and the app subnet(s) 926 can be communicatively coupled to the DB subnet(s) 930 contained in the control plane data tier 928 and to a service gateway 936 (e.g., the service gateway 636 of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include primary VNICs 964(1)-(N) that can be communicatively coupled to tenant virtual machines (VMs) 966(1)-(N) residing within the untrusted app subnet(s) 962. Each tenant VM 966(1)-(N) can run code in a respective container 967(1)-(N), and be communicatively coupled to an app subnet 926 that can be contained in a data plane app tier 946 that can be contained in a container egress VCN 968. Respective secondary VNICs 972(1)-(N) can facilitate communication between the untrusted app subnet(s) 962 contained in the data plane VCN 918 and the app subnet contained in the container egress VCN 968. The container egress VCN can include a NAT gateway 938 that can be communicatively coupled to public Internet 954 (e.g., public Internet 654 of FIG. 6).

The Internet gateway 934 contained in the control plane VCN 916 and contained in the data plane VCN 918 can be communicatively coupled to a metadata management service 952 (e.g., the metadata management system 652 of FIG. 6) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively couple to cloud services 956.

In some examples, the pattern illustrated by the architecture of block diagram 900 of FIG. 9 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 967(1)-(N) that are contained in the VMs 966(1)-(N) for each customer can be accessed in real-time by the customer. The containers 967(1)-(N) may be configured to make calls to respective secondary VNICs 972(1)-(N) contained in app subnet(s) 926 of the data plane app tier 946 that can be contained in the container egress VCN 968. The secondary VNICs 972(1)-(N) can transmit the calls to the NAT gateway 938 that may transmit the calls to public Internet 954. In this example, the containers 967(1)-(N) that can be accessed in real-time by the customer can be isolated from the control plane VCN 916 and can be isolated from other entities contained in the data plane VCN 918. The containers 967(1)-(N) may also be isolated from resources from other customers.

In other examples, the customer can use the containers 967(1)-(N) to call cloud services 956. In this example, the customer may run code in the containers 967(1)-(N) that requests a service from cloud services 956. The containers 967(1)-(N) can transmit this request to the secondary VNICs 972(1)-(N) that can transmit the request to the NAT gateway that can transmit the request to public Internet 954. Public Internet 954 can transmit the request to LB subnet(s) 922 contained in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, 900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

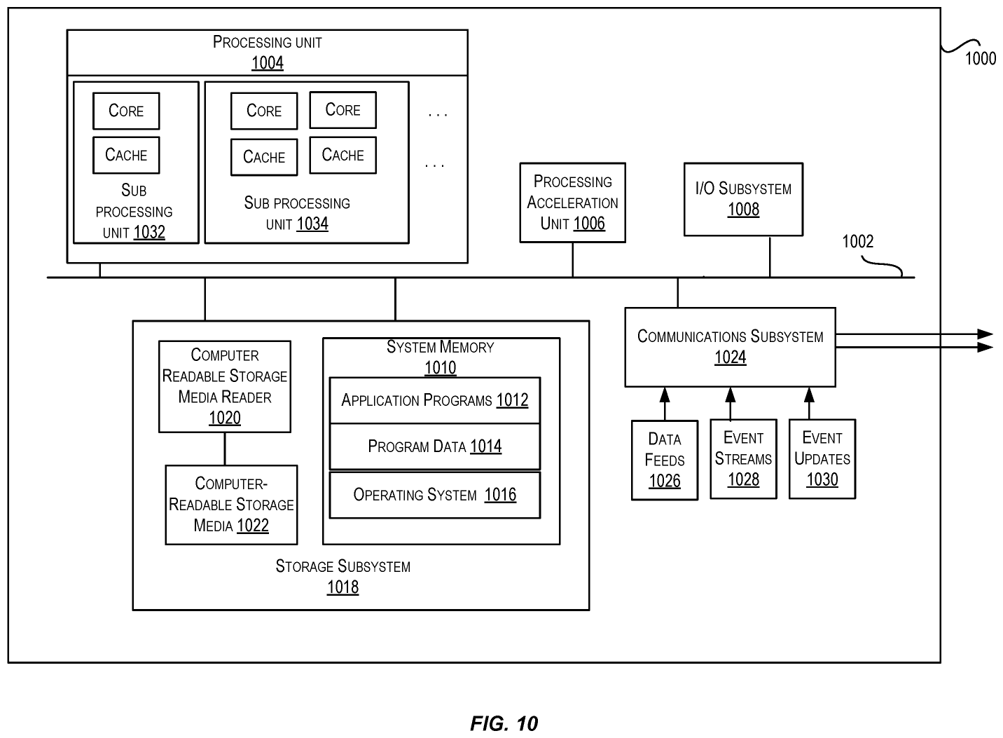

FIG. 10 illustrates an example computer system 1000, in which various embodiments may be implemented. The system 1000 may be used to implement any of the computer systems described above. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processor(s) 1004 and/or in storage subsystem 1018. Through suitable programming, processor(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1000 may comprise a storage subsystem 1018 that comprises software elements, shown as being currently located within a system memory 1010. System memory 1010 may store program instructions that are loadable and executable on processing unit 1004, as well as data generated during the execution of these programs.

Depending on the configuration and type of computer system 1000, system memory 1010 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1004. In some implementations, system memory 1010 may include multiple different types of memory, such as static random access memory (SRAM) or dynamic random access memory (DRAM). In some implementations, a basic input/output system (BIOS), containing the basic routines that help to transfer information between elements within computer system 1000, such as during start-up, may typically be stored in the ROM. By way of example, and not limitation, system memory 1010 also illustrates application programs 1012, which may include client applications, Web browsers, mid-tier applications, relational database management systems (RDBMS), etc., program data 1014, and an operating system 1016. By way of example, operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1018 may also provide a tangible computer-readable storage medium for storing the basic programming and data constructs that provide the functionality of some embodiments. Software (programs, code modules, instructions) that when executed by a processor provide the functionality described above may be stored in storage subsystem 1018. These software modules or instructions may be executed by processing unit 1004. Storage subsystem 1018 may also provide a repository for storing data used in accordance with the present disclosure.

Storage subsystem 1000 may also include a computer-readable storage media reader 1020 that can further be connected to computer-readable storage media 1022. Together and, optionally, in combination with system memory 1010, computer-readable storage media 1022 may comprehensively represent remote, local, fixed, and/or removable storage devices plus storage media for temporarily and/or more permanently containing, storing, transmitting, and retrieving computer-readable information.

Computer-readable storage media 1022 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information and which can be accessed by computing system 1000.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments communications subsystem % 524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 302.11 family standards, or other mobile communication technologies, or any combination thereof), global positioning system (GPS) receiver components, and/or other components. In some embodiments communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
receiving, by a computing device, a time series comprising a first time step value and a second time step value;
generating, by the computing device, a temporally aggregated time series by summing the first time step value and the second time step value to create a third time step value;
calculating, by the computing device, a first set of input values from the time series and a second set of input values from the temporally aggregated time series, the first set of input values and the second set of input values being based at least in part on a same set of input features; and
forecasting, by the computing device, a fourth time step value using the first set of input values from the time series, and a fifth time step value using the second set of input values from the temporally aggregated time series.

2. The computer-implemented method of claim 1, wherein the computing device implements a first machine learning forecasting model to forecast the fourth time step value and a second machine learning model to forecast a fifth time step value.

3. The computer-implemented method of claim 2, wherein both the first machine learning model and the second machine learning model implement a same forecasting technique.

4. The computer-implemented method of claim 3, wherein the forecasting technique is an autoregressive moving average technique.

5. The computer-implemented method of claim 1, wherein the first set of input values comprises a trend, a seasonality, an autocorrelation, a nonlinearity, or a heterogeneity of the time series.

6. The computer-implemented method of claim 1, wherein the method further comprises discarding a sixth time step value, and wherein the sixth time step value is an oldest time step value of the time series.

7. The computer-implemented method of claim 3, wherein the method further comprises training the first machine learning model via the forecasting technique.

8. A cloud infrastructure node, comprising:
a processor; and
a computer-readable medium including instructions that, when executed by the processor, cause the processor to:
receive a time series comprising a first time step value and a second time step value;
generate a temporally aggregated time series by summing the first time step value and the second time step value to create a third time step value;
calculate a first set of input values from the time series and a second set of input values from the temporally aggregated time series, the first set of input values and the second set of input values being based at least in part on a same set of input features; and
forecast a fourth time step value using the first set of input values from the time series, and a fifth time step value using the second set of input values from the temporally aggregated time series.

9. The cloud infrastructure of claim 8, wherein the instructions, when executed by the processor, further cause the processor to implement a first machine learning forecasting model to forecast the fourth time step value and a second machine learning model to forecast the fifth time step value.

10. The cloud infrastructure node of claim 9, wherein both the first machine learning model and the second machine learning model implement a same forecasting technique.

11. The cloud infrastructure node of claim 10, wherein the forecasting technique is an autoregressive moving average technique.

12. The cloud infrastructure node of claim 8, wherein the first set of input values comprises a trend, a seasonality, an autocorrelation, a nonlinearity, or a heterogeneity of the time series.

13. The cloud infrastructure node of claim 8, wherein the instructions, when executed by the processor, further cause the processor to discard a sixth time step value, and wherein the sixth time step value is an oldest time step value of the time series.

14. The cloud infrastructure node of claim 10, wherein the instructions, when executed by the processor, further cause the processor to train the first machine learning model via the forecasting technique.

15. A non-transitory computer-readable medium having stored thereon a sequence of instructions which, when executed, causes a processor to perform operations comprising:
receiving a time series comprising a first time step value and a second time step value;
generating a temporally aggregated time series by summing the first time step value and the second time step value to create a third time step value;
calculating a first set of input values from the time series and a second set of input values from the temporally aggregated time series, the first set of input values and the second set of input values being based at least in part on a same set of input features; and
forecasting a fourth time step value using the first set of input values from the time series, and a fifth time step value using the second set of input values from the temporally aggregated time series.

16. The non-transitory computer-readable medium of claim 15, wherein the instructions, when executed by the processor, further cause the processor to implement a first machine learning forecasting model to forecast the fourth time step value and a second machine learning model to forecast the fifth time step value.

17. The non-transitory computer-readable medium of claim 16, wherein both the first machine learning model and the second machine learning model implement a same forecasting technique.

18. The non-transitory computer-readable medium of claim 17, wherein the forecasting technique is an autoregressive moving average technique.

19. The non-transitory computer-readable medium of claim 15, wherein the first set of input values comprises a trend, a seasonality, an autocorrelation, a nonlinearity, or a heterogeneity of the time series.

20. The non-transitory computer-readable medium of claim 15, wherein the instructions, when executed by the processor, further cause the processor to discard a sixth time step value, and wherein the sixth time step value is an oldest time step value of the time series.
